(19) United States
(12) Patent Application Publication
(10) Pub. No.: US 2019/0130371 A1
(43) Pub. Date: May 2, 2019

(54) PAYMENT REDIRECTION SYSTEM

(71) Applicant: Andre HALE, NSW (AU)

(72) Inventor: Andre HALE, NSW (AU)

(21) Appl. No.: 16/306,259

(22) PCT Filed: Jun. 2, 2017
(86) PCT No.: PCT/AU2017/000125

§ 371 Date: Nov. 30, 2018

(30) Foreign Application Priority Data
Jun. 2, 2016 (AU) 2016902125

(51) Int. Cl. G06Q 20/10; G06F 16/23; G06Q 20/20; G06Q 20/32

(52) U.S. Cl. CPC G06Q 20/10; G06F 16/2379; H04W 4/80; G06Q 20/3274; G06Q 20/3278; G06Q 20/202

(57) ABSTRACT

A method of transacting wherein a proffered amount comprises a payment amount and an overpayment amount; the payment amount being equal to the transaction amount; the overpayment amount being denominated as a note denomination and a coin denomination; and wherein the merchant returns the note denomination in notes; the merchant transfers the coin denomination to an electronic account for distribution at the direction of the purchaser; and a method of redirecting receipt of coinage further requiring communication between at least three entities over three distinct communication channels of at least one data item; and means for verifying an entities entitlement to the receipt of coinage whereby a third entity compares both of a coinage amount and code value sent independently to the third party by a first entity and a second entity, the third entity only issuing a validation event if both comparisons evaluate to true.

### TECHNICAL FIELD

The present invention relates to payment systems and, more particularly but not exclusively, payment systems which seek to manage and distribute at least portions of overpayments in any given transaction. In particular but not exclusive forms the invention relates to a topology and programming methodology for giving effect to such systems.

### BACKGROUND

Where transactions are conducted in a local currency, so-called “cash” transactions are not unusual even though many transactions these days are conducted entirely in an electronic form for example using charge cards, credit cards or the like. Particularly in the case of a cash transaction, a transaction will comprise a payment which includes an overpayment. This is particularly so where local currency provides for banknotes and coinage. Banknotes are typically denominated in whole currency amounts (for example a whole dollar amount). So where a purchaser offers only banknotes it is not unusual for the total amount offered by way of banknotes to comprise the actual transaction payment plus an overpayment portion. The overpayment portion is usually returned to the purchaser as “change”. In nearly all instances the “change” will include coinage and may also include banknotes.

Banknotes are considered convenient to handle and store-for example in a pocket or in a wallet-because they are typically made from paper or a thin planar plastics material thereby rendering them foldable and pliable. Coinage on the other hand, whilst smaller in size per-unit, becomes heavy in the aggregate. For any given volume occupied by coinage it will store less currency value than the same volume occupied by banknotes.

It would be advantageous if there was apparatus and a methodology available to assist in transactions requiring distribution of change resulting from an overpayment particularly with a view to dispensing with the need to pay the change for at least portions of it in coinage and still allowing the purchaser to control the distribution of the coinage and more particularly the value of the coinage. In effect it would be advantageous if the coinage portion of a transaction more particularly a transaction relating to the repayment of overpayment in the form of change being returned to a purchaser in relation to the transaction could be substituted by transmission of representative data in the form of an electronic transaction. In further particular forms it will be advantageous to provide a topology and programming methodology for giving effect to such systems.

### BACKGROUND

The broad problem to be solved by US 20160328692 to Camps (earliest priority date claimed 7 May 2015) is how to do away with the inconvenience of receiving physical change amounts “in the hand” in a transaction conducted by a user with a merchant at point of sale and yet permit/facilitate the user to still retain entitlement to and use of the physical change amount.

In its broadest form the transaction may be electronic in the forward direction or it may comprise use of currency in the forward direction. The issue is what to do with the difference between amount proffered in the forward direction and the amount to be returned to the user in a return direction (the “return amount”) where the amount proffered is greater than the value of the transaction.

Broadly the solution revealed by the prior art is to calculate at the point of sale the physical change amount and convert at the point of sale the physical change amount to an electronic value representing the physical change amount. At the same time the electronic value is associated electronically with the user which initiated the transaction sufficient that the user may make use of the electronic value at the user's direction. Very early citations US 20030040927 (Saito) published in 2003 and US 20050080737 (Stein) published in 2005 disclose this concept and the solution. [The forward transaction being currency in these citations]

Earlier prior art utilises a portable digital device in the form of a stored value card operable in conjunction with POS terminals to achieve this solution-see US 7284696 to Begola published in 2006. [The forward transaction being currency in this instance]

Later prior art progresses these concepts, namely WO2007/044925 published in 2007 to Aggarwal [also published as US20070131760]. In this instance the portable digital device may be a smart card or may be an electronic device containing a SIM (claim 6) and being a “networked device” (claim 12) [The forward transaction being currency in this instance]

More recent prior art seeks to make use of a portable digital device in the form of a smart phone operable in conjunction with POS terminals as the mechanism for facilitating the solution-see for example US 20120078751 to MacPhail published in 2012. [the forward transaction being electronic in this instance]

Camps

Sharing:

A sub-problem identified by Camps is how to “share” at the user's direction the electronic value representing the physical change amount. The solution to this sub problem requires identifying electronically the other party with whom the user wishes to share at least a portion of the electronic value representing the physical change amount.

In the claims of Camps the sub-problem is addressed by defining a “sharing account” having stored therein “sharing account data associated with each of a plurality of registered sharing accounts”. (Independent claim 1)

Whilst the “sharing account” appears as a distinct element in the claims and the drawings of Camps it is to be noted that Camps states in the last sentence of paragraph 0061 thereof that the function of the sharing account may be incorporated in another account viz: “it will be nonetheless appreciated that whilst distinct accounts are considered herein these distinct accounts need not necessarily constitute physically distinct accounts but rather could also be defined by a same physical account destination provided transfer funds are appropriately designated and/or annotated in related transaction records to reflect their respective intended beneficiary”

Sharing Directive:

Where it is envisaged that the electronic value may be shared with one or more of a multiplicity of parties there needs to be a mechanism for the user to direct the electronic value to a selected one or ones of the parties.

The mechanism for directing the electronic value to a selected one or ones of the parties is provided in claim 1 by the feature “display a selectable sharing option to the given user via a graphical user interface of said mobile device in which information pertaining to said given sharing account is visibly rendered for the given user . . . ” and subsequently “communicate user selection of said sharing option to set a transaction server in response to said user selection so to invoke an electronic transfer of funds corresponding to said sharing amount from said available sharing balance to said sharing account”.

In independent claim 18 this mechanism is provided by the feature “display a selectable sharing option via a graphical user interface of said mobile device in which information pertaining to said given sharing account is visibly rendered . . . Communicate said selection of said sharing option to said server to invoke an electronic transfer of funds corresponding to said sharing amount from said available sharing balance to said sharing account”.

Tips:

In a particular form the sharing includes sharing at least a portion of the physical change amount with the merchant with whom the transaction has been conducted-commonly known as providing a “tip”.

It follows that if the sharing is to be with the merchant with whom the transaction has been conducted (for example in order to provide a tip) then the identity of the merchant or a merchant account of that merchant must be ascertained in the course of the transaction.

The ability to share with the merchant is addressed by the feature “wherein each of said sharing accounts is directly or indirectly associated with a respective retailer account”. (Independent claim 1)

In the alternative the ability to share with the merchant is addressed by the feature “receive identification of a given sharing account associated with the POS location” (Independent claim 18).

Broadly Aggarwal discloses all of the features of the Camps claims discussed above-it's abstract reads: In a system where a customer makes a purchase with a merchant using currency, methods are provided for enabling the customer to receive change electronically. The customer has a customer identification device that is associated with a change account stored at a change server. The merchant also has a change account associated with a change server. A change settlement occurs between the customer change account and the merchant change account to transfer some or all of the change to the customer change account.

In Aggarwal the portable digital device may be a smart card or may be an electronic device containing a SIM (claim 6) and being a “networked device” (claim 12). That is, an electronic device connectable to and transmitting over the mobile/cell telephone network may provide the necessary identity information for the user.

Aggarwal discloses use of a merchant change account and a customer change account having the ability to transfer funds from one to the other in a manner whereby a tip can be conferred. In this instance and as contemplated by Camps the sharing account function is incorporated in one or other of the merchant change account or the customer change account of Aggarwal.

### PRIOR ART

Commercial systems such as Acorns allow users to make use of “round-ups”—that is to say the difference between a change amount and a whole dollar above that amount. These systems are intended for credit card transactions.

Other prior art publications include:

EP 0789887 A assigned to VISA INTERNATIONAL discloses:

Data capture which occurs at the consumer end of an electronic bill pay transaction is assisted by machine readable information in a standardized format on an invoice where the machine readable information includes biller identification and a C-B account number and the information is readable at the consumer end (S2) without prior arrangements being made specifically between the consumer and the biller. The biller identification is either a universal biller reference number or sufficient information to allow manual identification and contact with the biller (S8). The machine readable information is an optically-readable bar code, characters in a font designed for error-free character recognition by optical or magnetic means

W02003009243 A assigned to W 3 INFOCOMM GROUP

discloses:

A mobile virtual e-purse micro-payment method and system is provided. The consumer keys in a formatted SMS instruction and sends this to a specified telephone number to effect micro-payment from a monetary funds account which may include a stored-value virtual electronic purse account or an issuing bank account from which funds may be directly debited to his selected merchant. A security feature is provided in which the unique MSISDN phone number identifier and the USERID serve to identify the consumer. For added security the consumer gets a formatted voice call asking him to confirm the payment instructions and to key in his PIN (Person Identification Number). The invention also provides for simple, effective multi-modal return paths via simple fax, e-mail or phone confirmation giving physical records to the merchant that payment has been made.

US 110270749 A assigned to INVOICE CLOUD INC

discloses:

A method and system for generating and presenting invoices or bills from a biller to a payer. The bills are generally sent to the payer on a branded virtual site to look like the biller's website. Single or multiple bills will be presented to the payer through email notifications. The payer would have the option of paying the entire bill or portions of the bill utilizing various methods of payments, such as e-checks, paper checks, credit or debit cards as well as automatic withdrawal from a checking or savings account. The payer would also have the option of electing a paperless billing system instead of receiving both email as well as paper notifications of a particular bill or bills.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

### Definitions

Portable digital communications device: in this specification a portable digital communications device is a device which includes at least a processor in communication with a memory for execution for applications stored in the memory and in respect of which there is at least an input output device which allows a user to communicate information to the processor and receive information from the processor. The portable digital communications device further includes a communications device for receipt of data from sources external to the portable digital communications device and for transmission of data to sources external to the portable digital communications device. In particular forms the communication facility includes the ability to receive data from GPS or like geolocation systems. In particular forms the portable digital communications device may be in the form of a smart phone such as presently marketed by firms such as Apple, Google and Samsung.

Scannable code: in this specification a scannable code may take the form of a barcode or QR code. A scannable code is a source of data which can be read by a short range communications facility. Such a facility can be based on Bluetooth radio communications or infrared or visible light transmission or may take the form of a near field communications capability. Typical range for these facilities is up to 10 metres although more preferably operational over 1 metre or less.

Deposit: in this specification, when used in the context of funds transfer deposit is to be taken to cover actions such as transfer of funds from one account to another or redeem funds from an account.

Account: in this specification an account denotes a holding facility for funds for a user. This may take the form of a bank account operated by a deposit taking institution. It may also take the form of e.g. a Paypal brand account or may take the form of a non-fiat currency account such as a bitcoin virtual currency account.

Accordingly, in one broad form of the invention there is provided in a transaction between a purchaser and a merchant, which has a transaction value comprising a transaction amount; a method of transacting wherein:
a. The purchaser transfers a proffered amount greater than the transaction amount to the merchant; said proffered amount comprising a payment amount and an overpayment amount; the payment amount being equal to the transaction amount.
b. And wherein the overpayment amount is denominated as a note denomination and a coin denomination;
c. and wherein the merchant returns the note denomination in notes; the merchant transferring the coin denomination to an electronic account for distribution at the direction of the purchaser.

Preferably the electronic account is controlled by an application executing on a digital device.

Preferably the digital device is a smart phone.

Accordingly, in a further broad form of the invention there is provided a method for non-physical distribution of change or a selected portion of the change arising from a transaction; said methodology comprising
a. Entering the value of the change or a selected portion of the change as a data item in a database;
b. Loading a control and direction application onto a digital device;
c. the control and direction application accessing the data item on the database and transferring a copy of the data item to a memory on the digital device.

Preferably the data item comprises a coin denomination in the form of a coin data item.

Accordingly, in a further broad form of the invention there is provided a mechanism for allowing transfer of a portion of funds at the direction of purchaser; the mechanism comprising;
a. A point of sale terminal
b. A portable digital device
c: And wherein a data item is transmitted from the portable digital device to the point of sale terminal
d. And wherein the data item is then on transmitted to a webserver

In yet a further broad form of the invention there is provided a method of redirecting receipt of coinage due to a recipient; said method comprising calculating the value of the coinage due to the recipient as a coinage calculation event; saving the value of the coinage due to the recipient as a data item; communicating the data item to the recipient; at substantially the same time as the calculation event calculating a calculation event identifier; communicating the calculation event identifier to the recipient; communicating the calculation event identifier to a database.

Preferably, the step of redirecting requires the recipient to communicate the calculation event identifier to a database.

Preferably, the calculation event identifier is in the form of a PIN.

Preferably, the data item and the calculation event identifier communicated together to the recipient.

Preferably, the data item and calculation event identifier communicated to the recipient on a single screen display.

Preferably, the step of calculating the value of the coinage is performed locally.

Preferably, the step of calculating the value of the coinage is performed at a remote location from the recipient.

In yet a further, broad form of the invention there is provided a method of redirecting receipt of coinage; the method requiring communication between at least 3 entities over 3 distinct communication channels of at least one data item.

Preferably, a value stored in the data item represents the value of the coinage due to a recipient.

Preferably, each of the communication channels is different from any other of the communication channels.

Preferably, one of the communication channels comprises the internet.

Preferably, one of the communication channels comprises a radio frequency transmission.

Preferably, one of the communication channels comprises infrared transmission.

Preferably, one of the communication channels comprises a serial combination of internet and radio frequency transmission.

Preferably, at least one channel utilises near field communications (NFC).

Preferably, at least one channel utilises QR code recognition.

Preferably, the data item is represented as a QR code.

Preferably, the data item is represented as a bar code.

In yet a further broad form of the invention there is provided a mechanism for verifying to a predetermined level of certainty that an entity entitled to the value of a coinage amount expressed as a digital value is the entity entitled to the value of the coinage amount expressed as a digital value; said method comprising

a first entity originating a coinage amount;
a second entity associating the coinage value with that coinage amount;
the second entity communicating the coinage amount and a code value to the first entity;
the second entity also communicating the coinage amount and the code value to a third entity;
the first entity independently communicating the coinage amount and code value to the third entity;
the third entity comparing the coinage amount received from the first entity and the coinage amount received from the second entity to derive a first comparison value; the third entity comparing the values of the code value received from the first entity with the code value received from the second entity to derive a second comparison value; the third entity issuing a validation event if and only if both the first comparison and the second comparison are true.

Preferably, a geographic location is determined for the first entity at a geographic location is determined for the second entity at substantially the same time that the first entity originates the coinage amount.

Preferably, the geographic location is determined by a global positioning system (GPS).

Preferably, the validation event is issued if and only if, in addition, the geographic location determined for the first entity and the geographic location determined for the second entity are within a predetermined distance of each other.

Preferably, the predetermined distance is 1000 m.

Preferably, the predetermined distance is 500 m.

Preferably, the predetermined distance is 100 m.

Preferably, the predetermined distance is 50 m.

Preferably, the predetermined distance is 10 m.

In yet a further broad form of the invention there is provided a network topology and programming methodology for a payment system; the topology comprising a database at a first location; the database including stored records, wherein record data in the stored records can be communicated to or further amended by receipt of data at at least a second location remote from the first location and a third location; the third location remote from the first location; the third location periodically in close range to the second location;

The stored records manipulable by a processor in communication with a memory; the processor and memory in communication with a communications facility and an input/output facility;
A portable communications device at the second location; the portable communications device including a processor in communication with memory and further in communication with a communications facility and an input/output facility, thereby to enable short range communications with the third location at least when the third location is in close range to the second location; the portable communications device further enabling communications with the first location; and wherein communications between the first location and the second location occur over a first channel; communications between the second location and the third location occur over a second channel, and communications between the third location and the first location occur over a third channel.

Preferably, there is provided a fourth channel in communication between the second location and at intermediary facility.

Preferably, data representing funds flow over the fourth channel is in one direction only.

Preferably, there is provided a fifth channel for communication between the intermediary facility and the first location.

Preferably, the intermediary facility verifies user records.

Preferably, data representing funds flow is transmitted to a fifth location upon receipt of a trigger signal.

Preferably, the trigger signal is instigated at the second location.

Preferably, the trigger signal is instigated by input by a user into an input/output interface of a portable communications device.

In yet a further broad form of the invention there is provided a smart phone incorporating media programmed to give effect to the method as described above.

In yet a further broad form of the invention there is provided a database incorporating a processor and memory; the memory including media incorporating code which, upon execution by the processor, gives effect to the method as described above.

In yet a further broad form of the invention there is provided an electronic communications terminal incorporating a processor and memory including media incorporating code which, upon execution by the processor, give effect to the method as described above.

Preferably, an API is utilised to incorporate the code into the memory.

### BRIEF DESCRIPTION OF DRAWINGS

Embodiments of the present invention will now be described with reference to the accompanying drawings wherein:

FIG. 1, illustrates a prior art cash transaction between a purchaser and a merchant.

FIG. 2 is a block diagram of an enhanced cash transaction in accordance with the present invention.

FIG. 3, is a block diagram of a cash payment redirection system complete with hardware components in accordance with a further embodiment.

FIG. 4 shows additional detail of exemplary screen data for a POS IO device and a purchaser digital device as would be displayed during a transaction.

FIG. 5 is a typical flowchart for a transaction utilizing the devices of FIGS. 3 and 4.

FIGS. 6 to 10 illustrate particular screen displays that may appear on a purchaser digital device during the course of a transaction in accordance with embodiments of the present invention.

FIG. 11 is a flow diagram of a facility according to a second preferred embodiment showing information and funds flow.

FIG. 12 is a flow diagram of a facility according to a third preferred embodiment showing information and funds flow.

FIG. 13 is a flow diagram of a facility according to a third preferred embodiment showing information and funds flow.

FIG. 14 is a flow diagram of a facility according to a fourth preferred embodiment showing information and funds flow.

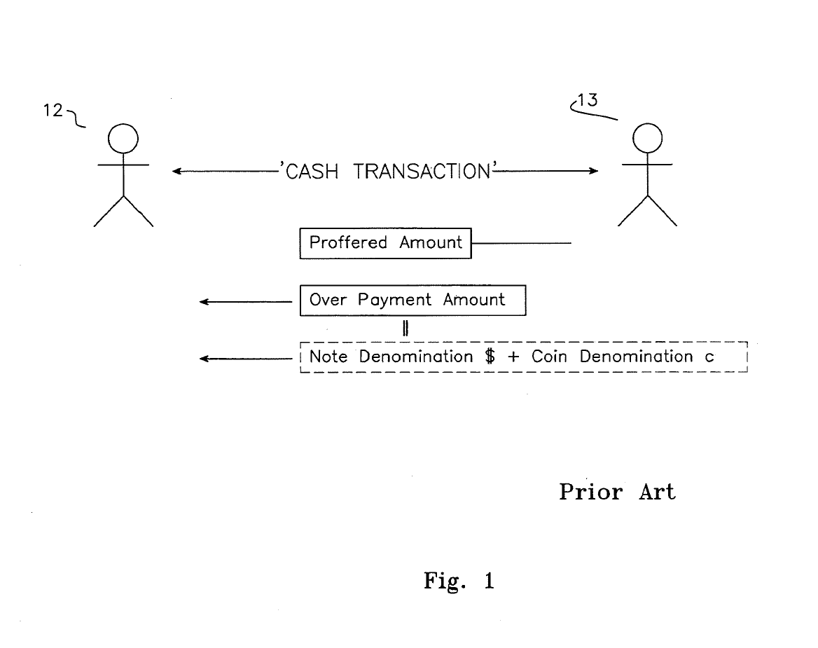

### DESCRIPTION OF EMBODIMENTS

### First Preferred Embodiment

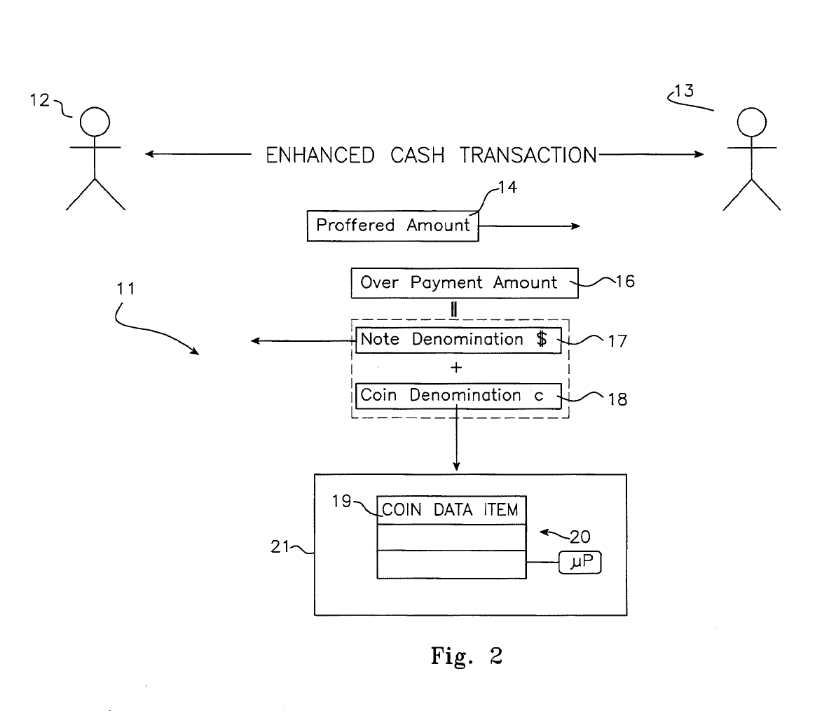

With reference to FIG. 2 the features of a first embodiment in accordance with a system 10 of the present invention relate to a transaction 11 between a purchaser 12 and a merchant 13. In preferred forms the transaction will comprise a transaction amount 15 nominated as full settlement for goods or services provided by the merchant 13 and received by the purchaser 12. The transaction 11 may be settled at least in part by use of currency in the form of cash and perhaps coin being transferred as a proffered amount 14 from the purchaser 12 to the merchant 13. In some instances the proffered amount 14 will comprise an overpayment in the form of an overpayment amount 16 in the form of an overpayment amount as compared with the transaction amount 15.

In this scenario it is common practice that the merchant 13 then transfers the difference between the overpayment amount 16 and the transaction amount 15 back to the purchaser 12 as “change”.

In practice the change itself may comprise currency denominated as a note denomination 17 and a coin denomination 18.

In preferred forms the present invention seeks to provide the change or at least a portion of it and more preferably the portion denoted as coin denomination 18 by way of an electronic transaction commencing with storage of the value of the coin denomination 18 as a coin data item 19 in at least a local memory 20 of a local digital device 21 at or around the time of the transaction 11.

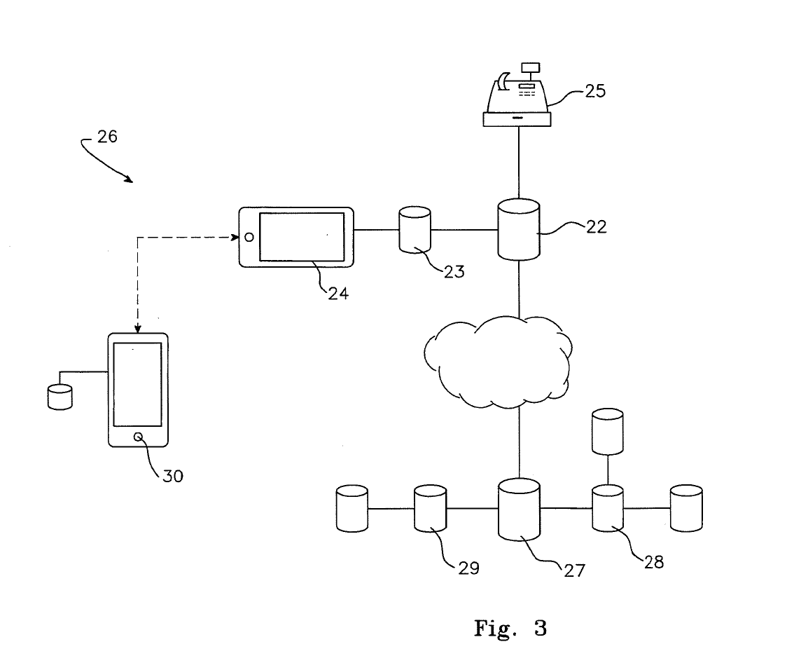

With reference to FIGS. 3 and 4 and 5 there will now be described a specific example utilizing a portable digital device such as smart phones and together with point of sale terminal devices thereby to give effect to the arrangement described with reference to FIG. 2.

With reference to FIG. 3 there is shown a point of sale device 22 which includes a memory loaded with a point of sale application 23 which is in communication with a point of sale input output device 24 which, in this instance, takes the form of a touch screen display. Optionally the point of sale device 22 may also communicate with a cash register 25

In this instance the point of sale device 22 is in communication with and forms part of a cash payment redirection system 26 forming a further preferred embodiment.

The cash payment redirection system 26 further includes a webserver 27 which maintains accounts for each user and each merchant participating in the system 26. In this instance purchaser accounts are maintained on purchaser database 28 and merchant accounts are maintained on merchant accounts database 29.

In use a purchaser 12 will utilize a purchaser digital device 30 in this instance in the form of a smartphone to communicate with the cash payment redirection 26 and more specifically each merchant device 22 at the time of any given transaction 11.

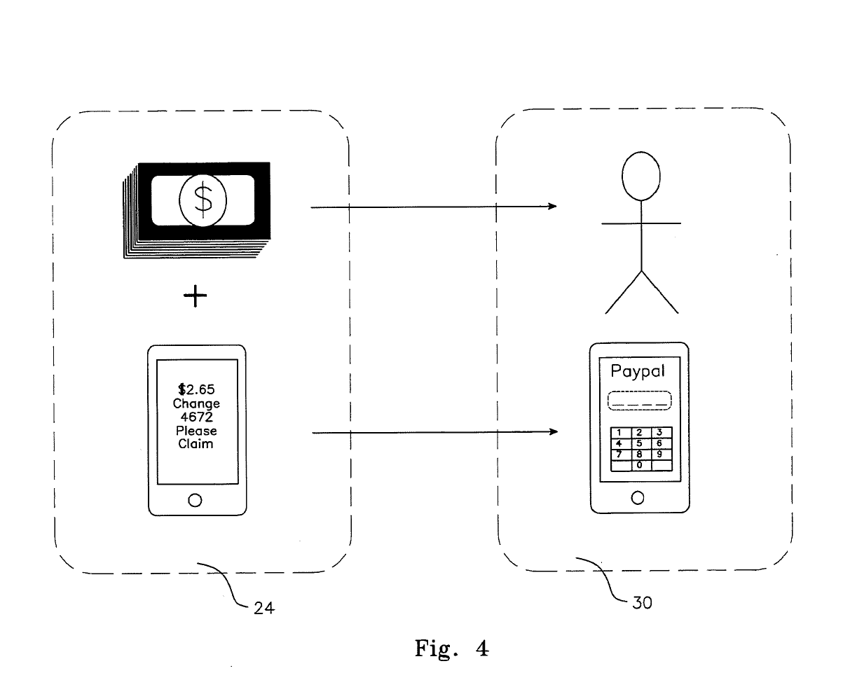

FIG. 4 shows additional detail of exemplary screen data for a POS IO device 24 and a purchaser digital device 30 as would be displayed during a transaction 11.

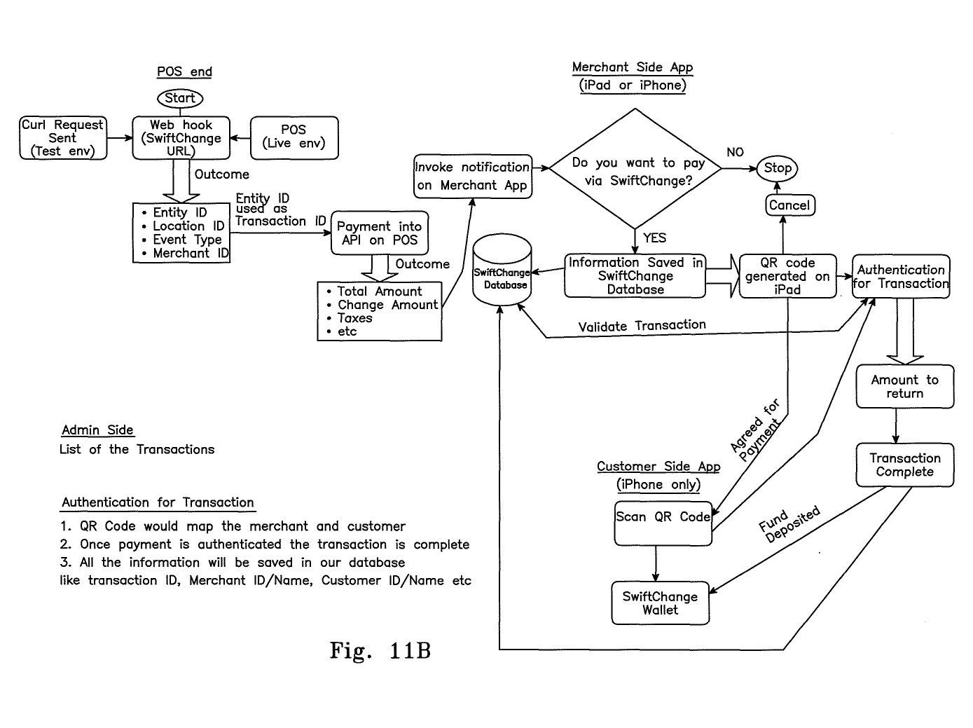

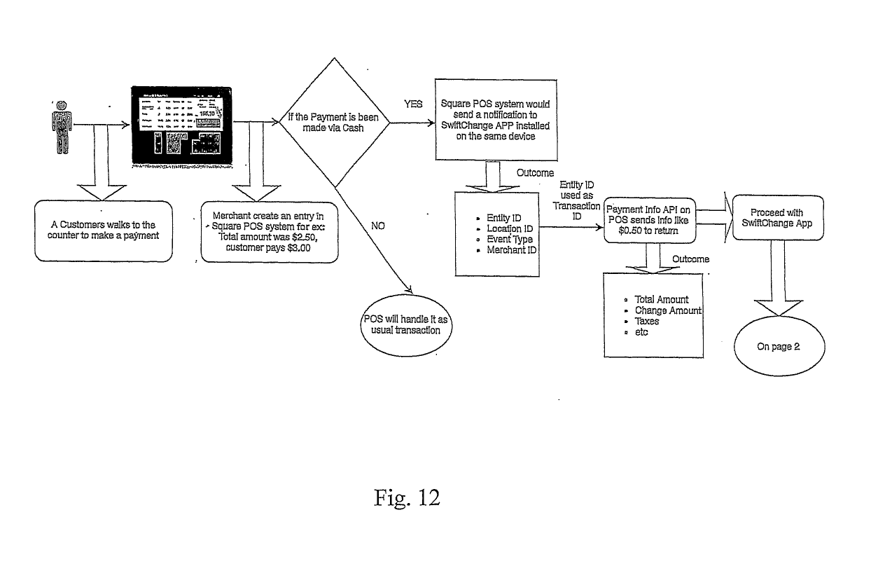

In this instance, the POS IO device 24 illustrates in numerical form that proportion of the change which can be claimed via the system, namely the coin denomination 18. This coin denomination 18 may be communicated by way of coin data item 19 to the purchaser digital device 30 for example via a QR code 31 as illustrated in FIG. 11 or via an NFC signal 32 as illustrated in FIG. 12.

In preferred forms the coin denomination 18 may then be made available to electronic account such as a PayPal account 33 via purchaser digital device 30.

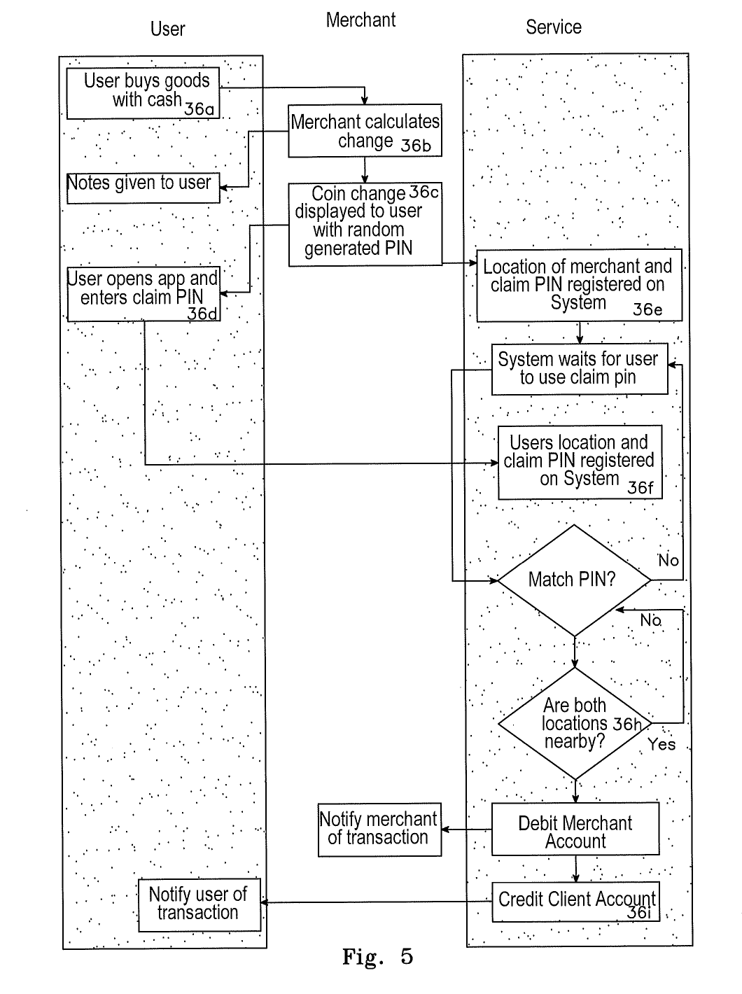

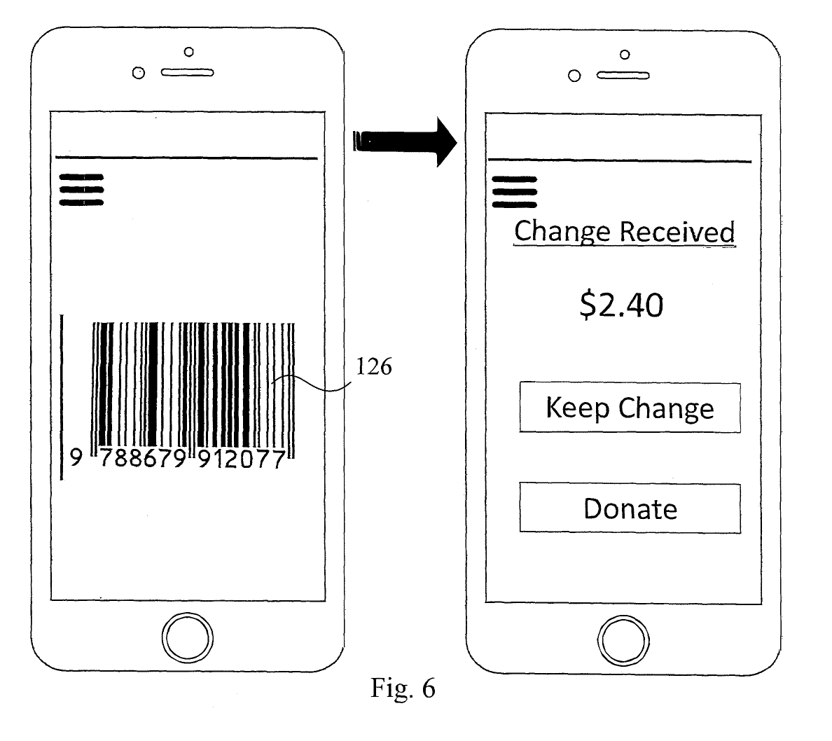

With reference to FIG. 5 a typical flowchart for a transaction 11 utilizing devices 24, 30 operates as indicated in the flowchart.

In preferred forms both a PIN 34 and geographic location 35 are utilized to add a level of authentication to the transaction. As illustrated in the steps of FIG. 5 a user or entity buys goods with cash (box 36a) the merchant entity involved in the transaction calculates change (box 36b). The merchant entity causes coinage value to be displayed to the user or entity together with a (preferably randomly generated) PIN (box 36c).

In this preferred form the user entity utilises a handheld digital device in order to enter the value of the coinage and the PIN (box 36d).

The value of the coinage and the pin communicated to and now known by the user entity is then communicated to a third location and third entity (box 36e).

At the time of the transaction the same coinage value relating to the transaction is communicated by the merchant entity (second entity) to the third location and third entity (box 36f)

the system at the third location checks the values obtained at step 36e and 36f and if and when they match (box 36e) a further check, in this embodiment, is also made as to whether the location of the user entity (first entity) and the location of the merchant entity (second entity) are within a predetermined distance (box 36h). The predetermined distance may be 1000 m, more preferably 500 m, more preferably 100 m, more preferably 50 m, more preferably 10 m.

Most preferably the locations are determined by use of GPS satellite positioning systems located at an operable by the user entity (first entity) and the merchant entity (second entity).

In this embodiment if all three of the coinage value, PIN and predetermined distance match then and only then is the value of the coinage (the coinage value) caused to be transferred to a client account (boxes 36h and 36i).

In preferred forms, at the same time, the merchant entity is notified at the second location that the transaction has been verified and completed (box 36k.

In a preferred form the user entity (first entity) is also notified that the transaction has been verified and completed (box 36l).

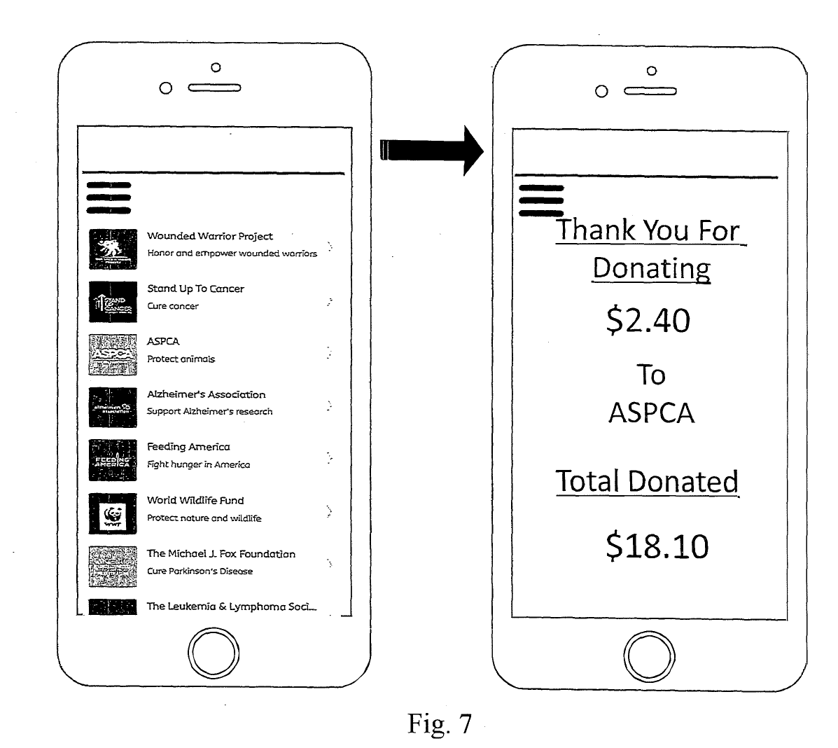

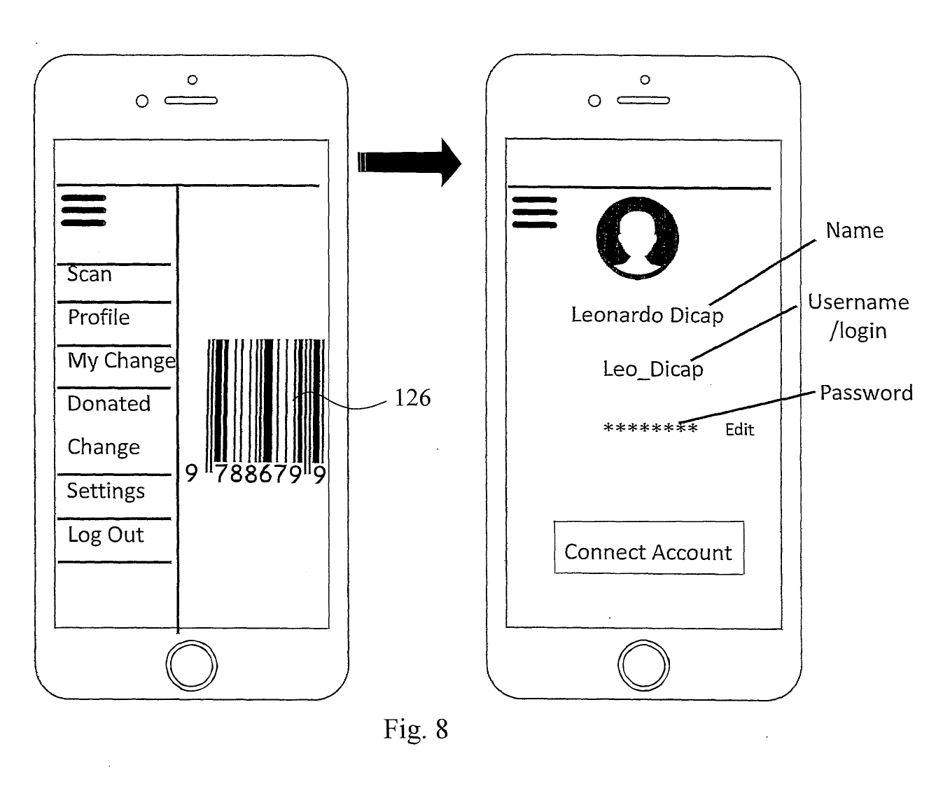

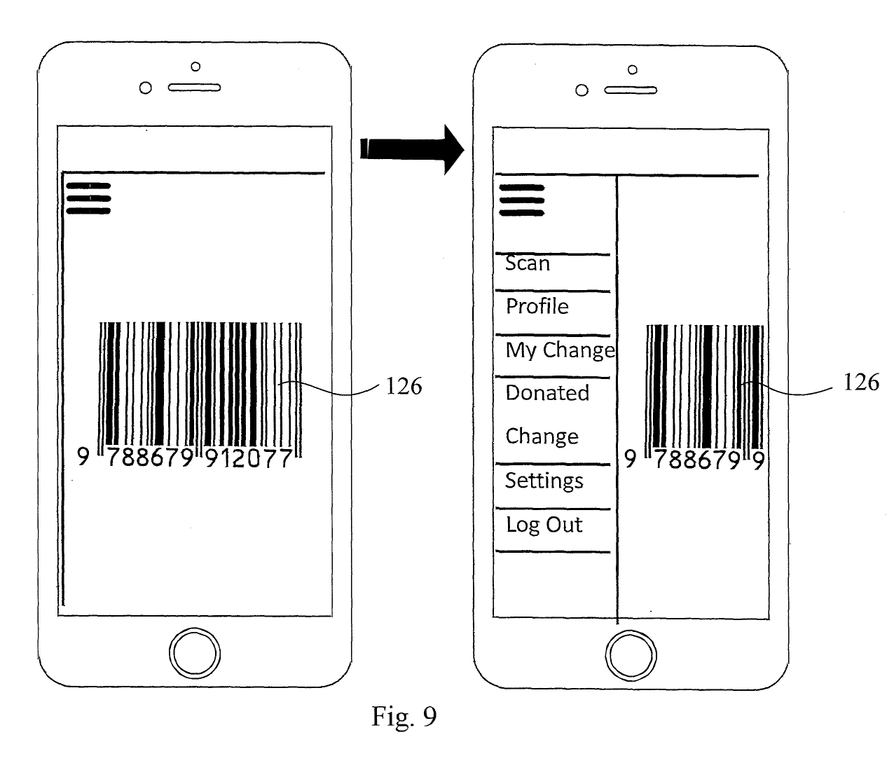

FIGS. 6 to 10 illustrate particular screen displays that may appear on purchaser digital device 30 during the course of a transaction 11.

In a particular form the user entity (first entity) may choose from a number of different variations when it comes to receiving change. I.e:
1. User can select to receive only coins electronically after an overpayment
2. User can select to receive all change after an overpayment, including bills
3. User can select to receive only coins when amount of overpayment is above a certain dollar amount. Eg. 1 If user pays $20 for item that is $16.50 and has previously selected to receive only coins when overpayment is above $4, then user will receive all $3.50 electronically. Eg. 2 If user pays $20 for item that is $15.50 and has previously selected to receive only coins when overpayment is above $4, then user will receive $0.50 electronically and be handed the $4 in bills.

### Second Preferred Embodiment

With reference to FIG. 11A and 11B, there is illustrated a second preferred embodiment in block diagram form. In this embodiment an application is made available for execution on a smartphone or like portable electronic communications device. In this embodiment the application is termed the “SwiftChange” application or otherwise the application of the second embodiment. Flow of funds according to this embodiment is as follows:

Customer to Merchant

When a customer pays for an item with cash that results in a change amount to be returned to the customer as notes or coins, they have the option to receive this amount on the SwiftChange app. To receive the change through SwiftChange, the customer scans the QR code displayed on the merchant's app when directed to do so. The customer is then sent a SwiftChange amount equal to the change amount they would receive in physical change. The customer confirms the SwiftChange amount and it is added to their SwiftChange balance. The customer performs these SwiftChange transactions at any store that utilizes SwiftChange and collects change through the app until they reach a value that they wish to deposit to their bank account.

Merchant to SwiftChange Admin

When a customer purchases an item with cash that results in a change amount to be given, the merchant will return this change amount through SwiftChange and keep the physical change amount. Every SwiftChange transaction will be added to a merchants billing total. This total is the amount of SwiftChange given to customers in a given time frame. This total change amount will be deducted automatically from the merchant's bank account and sent to SwiftChange administration holding account. The automatic billing cycle will be every week but a merchant may pay it earlier if they wish. This will be performed through payment gateway Stripe.

SwiftChange Administration to Customer

SwiftChange Administration will hold onto the customer's total SwiftChange balance until they send a deposit request through the app. When a customer requests the SwiftChange balance to be deposited to their bank account, the administration will send the requested amount minus a processing fee to the customers bank account. The money will be deposited through payment gateway Stripe.

FIG. 11. Diagram shows the flow of money with a single customer using SwiftChange at several stores.

SwiftChange Administration

SwiftChange will keep track of every transaction performed and will take note of the amount collected by the customer during a SwiftChange transaction and the amount given by the merchant. A profile for the merchant will show how much is to be deducted at the end of the week, and what customers performed a SwiftChange transaction at that store plus the SwiftChange amount given. A profile for the customer will show how much they have collected since their last deposit and the stores they collected the SwiftChange from.

### Third Preferred Embodiment

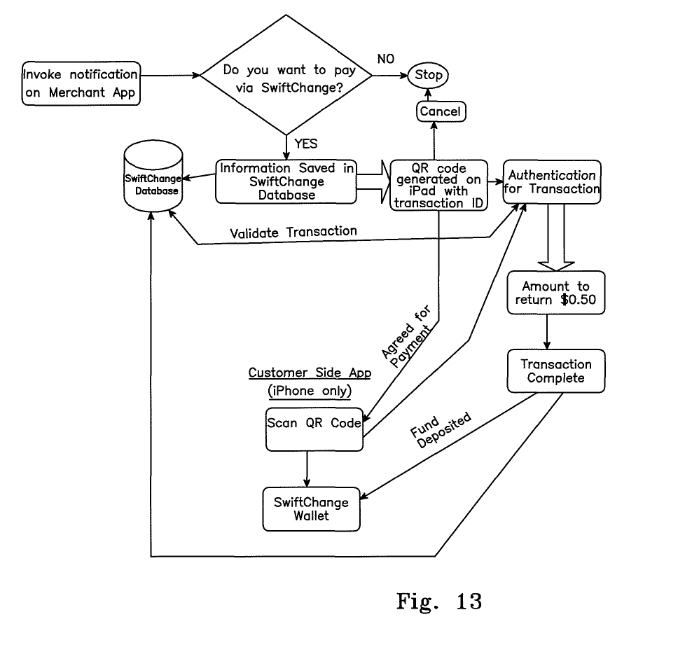

With reference to FIGS. 12 and 13 there is illustrated in flow chart form, funds flow according to a third preferred embodiment which makes use of a third party application and facility to assist in disbursements of funds received by the merchant. In this embodiment the third party application may be implemented using the SQUARE brand payments facility.

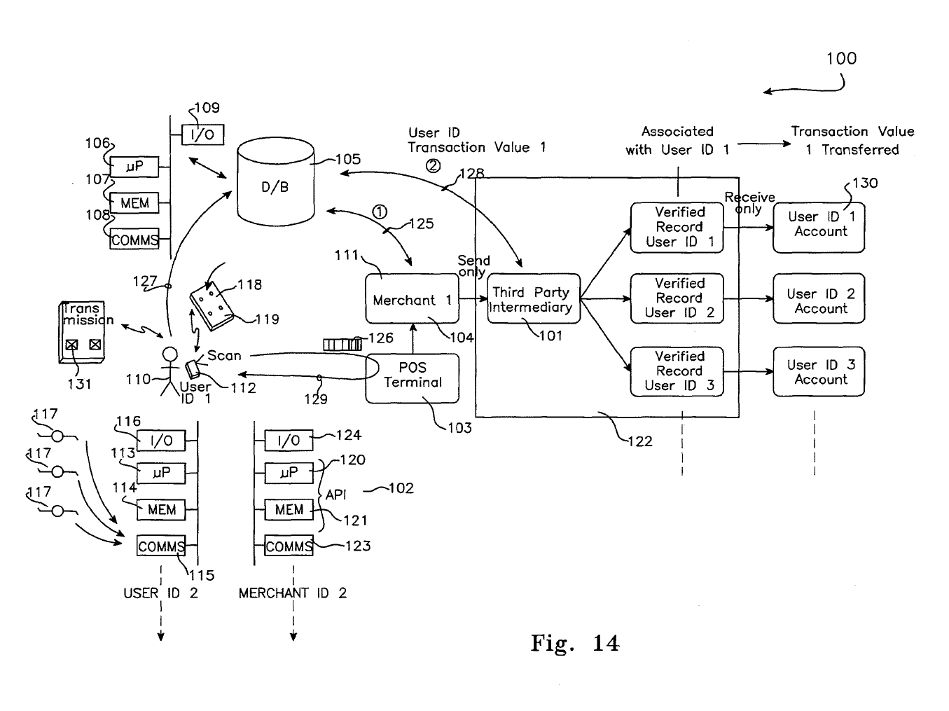

The topology for this approach is illustrated and described in greater detail with reference to FIG. 14.

### Fourth Preferred Embodiment

With reference to FIG. 14 there is illustrated a flow chart for funds flow according to a fourth preferred embodiment. In this instance the third party facility takes the form of a third party intermediary 101. In a preferred form the facility provided by the third party intermediary 101 is given effect by means of an API 102 installed on the POS terminal 103 of each merchant 104 which participates in the system 100 of the fourth embodiment. In a particular preferred form the system 100 may make use of the DWOLLA brand payments facility available in the USA.

With further reference to FIG. 14 the system 100 includes a database 105 in communication with at least a processor 106, a memory 107, a communications facility 108 and an input out facility 109. This arrangement permits communication of data from and to the database 105.

Database 105 holds electronic records representing transactional values for respective users 110, each user designated by a unique user ID: user ID 1; user ID 2 . . . user ID n.

The system 100 is further adapted to communicate with merchants 111, each respective merchant uniquely identifiable in the database 105 as merchant 1; merchant 2 . . . merchant n.

Each merchant 111 has available for use an electronic communications terminal 103 available for giving effect to and acquiring data in relation to transactions with respective users 110. In preferred forms the terminal 103 may take the form of a point of sale terminal or POS terminal.

Each user 110 has available a portable electronic communications device 112. In preferred forms the device 112 may take the form of a smart phone. This device will include a processor 113 in communication with a memory 114 to give effect to applications stored in the memory 114. The execution of the applications is assisted by a communications facility 115 and an input output facility 116. In particular preferred forms the communications device 112 includes within the communications facility 115 a GPS communications facility for communication with GPS satellites 117 thereby to facilitate geolocation capability on the communications device 112.

In particular forms a user 110 may utilise the geolocation facility to provide a substantially real-time map 118 on a display 119 of the device 112 showing locations of merchants 104, 111 that have terminals 103 programmed to participate in the system 100.

In preferred forms the terminal 103 includes a processor 120 in communication with a memory 121 thereby facilitating the terminal 103 to execute applications stored in the memory 121. In particular forms the application will include an application generated by means of an API 112. In particular forms the application generated by the API 112 gives effect to a third party funds transmission facility 122 operated by a third party intermediary 101.

The terminal 103 further includes a communications facility 123 and an input out facility 124 thereby to permit digital data action between the terminal 103 and the merchant 104, 111 and the portable digital communications device 112 of a user 110. The input output facility 124 and communications facility 123 further permits communication with database 105.

In preferred forms the technical means of communication between the terminal 103 and the database 105 is via channel 125. In preferred forms channel 125 is a wired communication channel. More preferably the channel 125 is a networked channel. In one form the networked channel 125 operates according to the TCP/IP protocol.

The terminal 103 includes the ability to make available a scannable code 126 for scanning by portable communications device 112. In alternative forms the terminal 103 includes the ability to acquire information or “read” a scannable code 126 residing on or emitted from device 112. In particular forms the scannable code may take the form of a barcode or QR code displayable on a display portion of either input output device 124 of terminal 103 or input output device 116 of portable communications device 112.

### In Use

In use funds transfer and retention and disbursement as described in earlier embodiments is given effect by the installation of an application in the memory 114 of the device 112 of each participating user 110. In addition an application is installed in the memory 121 of each terminal 103 of each participating merchant 104. In particular forms the application includes an application made available by API 102 thereby to enable communication with the third party intermediary system 102 in addition to communication with database 105.

In preferred forms the communication channel 127 for communication between device 112 and database 105 includes a wireless communications channel. In preferred forms this channel may be operable according to the GSM or like mobile communications network.

The channel 128 operable between third party intermediary and database 105 will include a wired communications system. In preferred forms this will be a networked system. In particular forms the network system will operate according to the TCP/IP protocol.

In preferred forms the communication channel 129 operable between terminal 103 and device 112 will be a short range electromagnetic communications channel. Such a facility can be based on Bluetooth radio communications or infrared or visible light transmission or may take the form of a near field communications capability. Typical range for these facilities is up to 10 metres although more preferably operational over 1 metre or less. This channel facilitates the transmission of data contained in the scannable code 126 between the terminal 103 and the portable communications device 112.

Funds flow and operation for this embodiment is as described in any one of the embodiments.

In addition, in this instance, the third party intermediary system 112 is operable to receive funds from merchant 111 as a “send only” operation. The funds verified with reference to each user ID of each user 110 before subsequent transmission in a “receive only” operation to the respective user account 130.

In alternative forms the funds in the send only operation may be directed to another account at the direction of the user 110. In preferred forms this direction is effected by use of the interface on device 112.

These operations are performed with reference to data transmitted over channel 128.

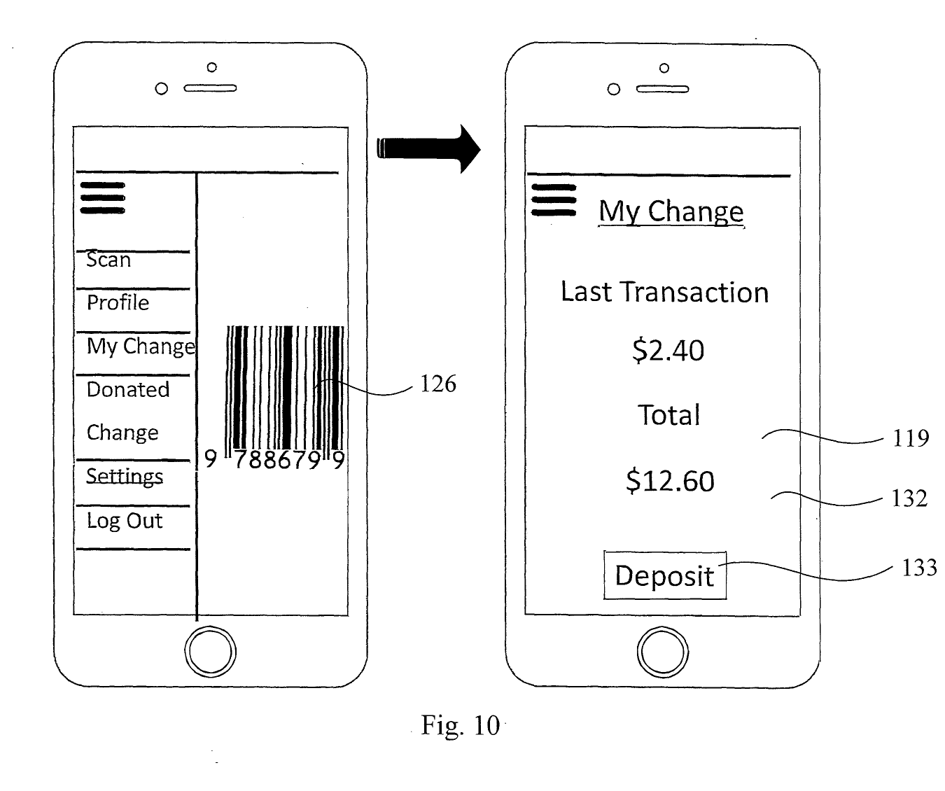

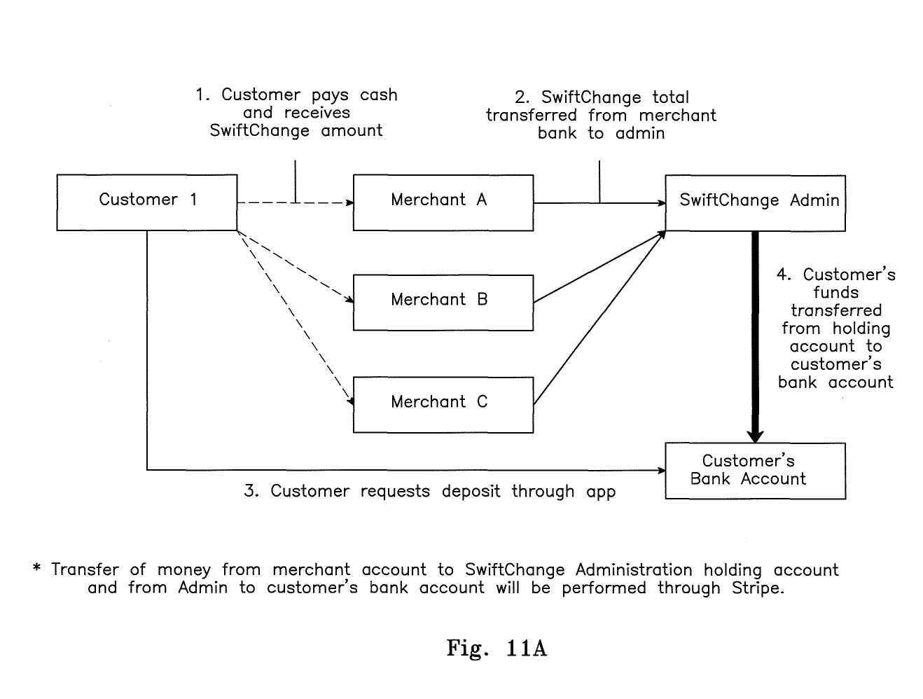

The receive only operation is triggered by respective user 110 communicating a “transmission” command 131 to database 105 over channel 127 which is then on communicated by channel 128 to the third party intermediary 101. In preferred forms the command is provided by way of interaction with a touch screen 132 on a smart phone. More particularly the triggered command can be given effect by touching the “deposit” button 133 displayed on screen 132 of the smart phone illustrated in FIG. 10.

In preferred forms the trigger is provided following accumulation of funds from multiple transactions with multiple merchants 111.

### API Facility

In a preferred form application code is provisioned in memory 121 of respective terminals 103 by use of an API 102. An example API coding facility to give effect to this is as follows:

[symbol]

NTRODUCTION [symbol]
etting Started (/docs/getting-started) [symbol]
equesting Sandbox Keys (/docs/sandbox-keys) [symbol]
PI Map (/docs/api-map) [symbol]
PI Initialization (/docs/api-initialization) [symbol]
PI Rate Limits (/docs/api-rate-limits) [symbol]
ommon Flow (/docs/common-flow) [symbol]
2P Flow (/docs/p2p-flow) [symbol]
arketplace Flow (/docs/marketplace-flow) [symbol]
ayout Flow (/docs/payout-flow) [symbol]
andbox Test Values (/docs/sandbox-test-values) [symbol]
ransaction Codes (/docs/transaction-codes) [symbol]
rrors (/docs/errors) [symbol]
ontact us (/docs/contact-us) [symbol]
SERS [symbol]
sers (/docs/user-resources)

Users (/docs/create-a-usercustomer)
Create User (/docs/create-a-user)
User (/docs/get-user)
Adding Documents (/docs/adding-documents)
Updating Existing Document (/docs/updating-existing-document)
Update User (/docs/update-user)
[Deprecated] Virtual Document (/docs/add-virtual-doc)
[Deprecated] Physical Document (/docs/add-physical-doc)

[symbol]

AUTH & FINGERPRINT [symbol]
Auth (/docs/oauth-resources)

OAuth User (/docs/get-oauth_key-refresh-token)
OAuth User Login (/docs/oauth-user-login)

[symbol]

ODES [symbol]
odes (/docs/node-resources)

Nodes (/docs/nodes)
ACH-US with Logins (/docs/add-ach-us-node)
ACH-US MFA (/docs/add-ach-us-node-via-bank-logins-mfa)
ACH-US with AC/RT (/docs/add-ach-us-node-via-acrt-s)
SYNAPSE-US (/docs/add-synapse-us-node)
TRIUMPH-SUBACCOUNT-US (/docs/triumph-subaccount-us)
RESERVE-US (/docs/reserve-us)
WIRE-US (/docs/add-wire-us-node)
WIRE-INT (/docs/add-wire-int-node)
IOU (/docs/add-iou-node)
Node (/docs/node)
Verify Micro-deposit (/docs/verify-micro-deposit)
Delete Node (/docs/delete-node)

[symbol]

RANSACTIONS [symbol]
ransactions (/docs/trans-resources)

Transactions (/docs/transactions)
Create Transaction (/docs/create-transaction)
Transaction (/docs/transaction)
Comment on Status (/docs/update-transaction)
Delete Transaction (/docs/delete-transaction)

SUBSCRIPTIONS
Subscriptions (/docs/subscriptions)

Subscriptions (/docs/subscriptions-1)
Create Subscription (/docs/create-subscription)
Subscription (/docs/subscription)
Update Subscription (/docs/update-subscription) [symbol]
indicates data missing or illegible when filed

[symbol]

Suggest Edits (/docs/api-map/edit)

### API Map

Following is the Map of the API

Following is a map of the entire API including all of the API calls that are supported and what you can do with each call.

| URL | HTTP Verb | Functionality | Notes |
|---|---|---|---|
| /oauth/<user:id> | POST | Get User's | This API call allows you |
| | | Access | to get access_tokens for |
| | | Token | users. |
| /oauth/<user:id>/login | POST | Get User's | |
| | | Refresh | |
| | | Token | |
| /users | GET | Get All Users | View all users |
| | | | (paginated). Search by |
| | | | name and email |
| | | | available. |
| /users | POST | Create User | Allows you to register a |
| | | | new user to Synapse |
| /users/<user:id> | GET | Get a User | View user′s details |
| | | | (paginated). Search by |
| | | | user type available |
| /users/<user:id> | PATCH | Update User | Here is where all user |
| | | Info | identity KYC, |
| | | | preferences, etc. will be |
| | | | updated. You can also |
| | | | refresh access to the |
| | | | user. |
| /users/<user:id>/nodes | GET | Get All User | View all user nodes |
| | | Nodes | (paginated). Search by |
| | | | node type available. |
| /users/<user:id>/nodes | POST | Create Node/ | Add bank accounts, |
| | | Do MFA | Synapse escrows or |
| | | | wire resources. |
| /users/<user:id>/nodes/<node:id> | GET | Get Node | View a node's details. |
| | | Info | |
| /users/<user:id>/nodes/<node:id> | PATCH | Verify Mico | If required when adding |
| | | Deposits | a node with routing |
| | | | details, you will verify it |
| | | | here. |
| /users/<user:id>/nodes/<node:id> | DELETE | Delete Node | This does not actually |
| | | | delete the node, but |
| | | | removes it from |
| | | | indexing. GET will still |
| | | | reveal the node, but user |
| | | | wil not show up in |
| | | | search. |
| /users/<user:id>/nodes/<node:id>/trans | GET | Get All | View all transactions of |
| | | Transactions | a user (paginated). |
| /users/<user:id>/nodes/<node:id>/trans | POST | Creat New | Send money from this |
| | | Trans | user to another user. |
| /users/<user:id>/nodes/<node:id>/trans/<trans:id> | GET | Get | View a single |
| | | Transaction | transaction. |
| /users/<user:id>/nodes/<node:id>/trans/<trans:id> | PATCH | Update | Used to communicate |
| | | Status Note, | with Synapse regarding |
| | | Add | queued transactions & |
| | | Attachments | adding transaction |
| | | | attachments. |
| /users/<user:id>/nodes/<node:id>/trans/<trans:id> | DELETE | Cancel | Only works if transaction |
| | | Transaction | has been created or |
| | | | queued. |
| /subscriptions | GET | Get All | View all subscriptions of |
| | | Subscription | a gateway (paginated). |
| /subscriptions | POST | Create New | Create a subscription |
| | | Subscription | with webhook |
| | | | preferences. |
| /subscriptions/<subscription:id> | GET | Get | View a since |
| | | Subscription | subscription. |
| /subscriptions/<subscription:id> | PATCH | Update | Update any information |
| | | scoe, url, | about a subscription. |
| | | is_active | |

### INDUSTRIAL APPLICABILITY

Embodiments of the present invention may be applied in ecommerce environments in order to “bridge the gap” between cash and electronic transactions.

Other embodiments seek to verify events to a predetermined level of certainty prior to a further triggering event occurring. Further embodiments provide specific forms of communication channel to give effect to the system of one or more of the embodiments. Still other forms provide a programming methodology in the form of an API to give effect to the system of one or more of the embodiments.

1.-45. (canceled)

46. A mechanism for allowing transfer of a portion of funds at the direction of purchaser; the mechanism comprising;
a. A point of sale terminal
b. A portable digital device
c. And wherein a data item is transmitted from the portable digital device to the point of sale terminal
d. And wherein the data item is then on transmitted to a webserver;
the mechanism executing a method for non-physical distribution of change which would otherwise be in the form of coin or a selected portion of the portion of funds as change arising from a transaction; said method comprising
entering the value of the change or a selected portion of the change as the data item in a database;
loading a control and direction application onto a digital device;
the control and direction application accessing the data item on the database and transferring a copy of the data item to a memory on the digital device.

47. A method of redirecting receipt of coinage due to a recipient; said method comprising calculating the value of the coinage due to the recipient as a coinage calculation event; saving the value of the coinage due to the recipient as a data item; communicating the data item to the recipient; at substantially the same time as the calculation event calculating a calculation event identifier; communicating the calculation event identifier to the recipient; communicating the calculation event identifier to a database; and wherein the method further comprises a method for non-physical distribution of the coinage due to the recipient as change which would otherwise be in the form of coin or a selected portion of the change arising from a transaction; said method comprising
entering the value of the change or a selected portion of the change as the data item in a database;
loading a control and direction application onto a digital device;
the control and direction application accessing the data item on the database and transferring a copy of the data item to a memory on the digital device.

48. The method of claim 47 wherein the step of redirecting requires the recipient to communicate the calculation event identifier to a database.

49. The method of claim 47 wherein the calculation event identifier is in the form of a PIN.

50. The method of claim 47 wherein the data item and the calculation event identifier communicated together to the recipient.

51. The method of claim 50 wherein the data item and calculation event identifier communicated to the recipient on a single screen display.

52. The method of claim 51 wherein the step of calculating the value of the coinage is performed locally.

53. The method of claims 47 wherein the step of calculating the value of the coinage is performed at a remote location from the recipient.

54. A method of redirecting receipt of coinage; the method requiring communication between at least 3 entities over 3 distinct communication channels of at least one data item.

55. The method of claim 54 wherein a value stored in the data item represents the value of the coinage due to a recipient.

56. The method of claim 54 wherein each of the communication channels is different from any other of the communication channels.

57. The method of claim 54 wherein one of the communication channels comprises the internet.

58. The method of claim 54 wherein one of the communication channels comprises a radio frequency transmission.

59. The method of claim 54 wherein one of the communication channels comprises infrared transmission.

60. The method of claim 54 wherein one of the communication channels comprises a serial combination of internet and radio frequency transmission.

61. The method of claim 54 wherein at least one channel utilises near field communications (NFC).

62. The method of claim 54 wherein at least one channel utilises QR code recognition.

63. The method of claim 54 wherein the data item is represented as a QR code.

64. The method of claim 54 wherein the data item is represented as a bar code.

65. A mechanism for verifying to a predetermined level of certainty that an entity entitled to the value of a coinage amount expressed as a digital value is the entity entitled to the value of the coinage amount expressed as a digital value; said method comprising
a first entity originating a coinage amount;
a second entity associating the coinage value with that coinage amount;
the second entity communicating the coinage amount and a code value to the first entity;
the second entity also communicating the coinage amount and the code value to a third entity;
the first entity independently communicating the coinage amount and code value to the third entity;
the third entity comparing the coinage amount received from the first entity and the coinage amount received from the second entity to derive a first comparison value; the third entity comparing the values of the code value received from the first entity with the code value received from the second entity to derive a second comparison value;
the third entity issuing a validation event if and only if both the first comparison and the second comparison are true;
the mechanism executing a method for non-physical distribution of change which would otherwise be in the form of coin or a selected portion of the portion of funds as change arising from a transaction; said method comprising
entering the value of the change or a selected portion of the change as the data item in a database;
loading a control and direction application onto a digital device;
the control and direction application accessing the data item on the database and transferring a copy of the data item to a memory on the digital device.
